(19) United States
(12) Patent Application Publication
(10) Pub. No.: US 2020/0131053 A1
(43) Pub. Date: Apr. 30, 2020

(54) USE OF COMPOSITE MEDIA FOR TREATMENT OF PRODUCED WATER FROM CHEMICAL ENHANCED OIL RECOVERY

(71) Applicant: Siemens Energy, Inc., Orlando, FL (US)

(72) Inventors: Matthew R. Patterson, Hatley, WI (US); Chad L. Felch, Kronenwetter, WI (US); Shane P. Wiercinski, Wausau, WI (US)

(21) Appl. No.: 16/621,270

(22) PCT Filed: May 24, 2018
(86) PCT No.: PCT/US2018/034370

§ 371 Date: Dec. 11, 2019

Related U.S. Application Data
(60) Provisional application No. 62/518,910, filed on Jun. 13, 2017.

(51) Int. Cl. C02F 1/28

(52) U.S. Cl. CPC C02F 1/288; C02F 1/286; C02F 2101/32; C08L 2207/062; C02F 1/285

(57) ABSTRACT

Systems and methods for treating a stream (12) from a chemical enhanced oil recovery (CEOR) process are disclosed. The method includes contacting the feed stream (12) with a plurality of media composite particles (20) to remove hydrocarbons from the feed stream (12); and generating a treated stream (40) comprising a reduced amount of the hydrocarbons and at least a majority of the viscosity-enhancing polymer remaining therein relative to the feed stream (12). The feed stream (12) includes the hydrocarbons, a concentration of a viscosity-enhancing polymer of at least about 10 mg/L, and an aqueous fluid. The media composite particles (20) each comprise a mixture of a cellulose-based material and a polymer.

### CROSS REFERENCE TO RELATED APPLICATIONS

This application claims priority to and the benefit of U.S. Provisional Application No. 62/518,910, filed Jun. 13, 2017, the entirety of which is incorporated by reference herein.

### FIELD

The present invention is directed to methods and systems for hydrocarbon removal, and in particular to methods and systems for removing hydrocarbons from a fluid, such as produced water, from an Enhanced Oil Recovery (EOR) extraction process. The methods and systems contact the fluid with a plurality of media composite particles, wherein each particle comprises a mixture of a cellulose-based material and a polymer.

### BACKGROUND

Oil production may be accomplished by injecting a fluid (typically an aqueous fluid) into a subsurface oil reservoir along with heat or chemical additives in order to increase an extent and efficiency of crude oil recovery. Thereafter, the hydrocarbon (e.g., oil) along with the injected fluid are extracted from the reservoir via a production or extraction well. The addition of additives (e.g., one or more of polymers, surfactants, and alkaline agents) to improve oil recovery may be referred to as a chemical enhanced oil recovery (CEOR) process. When utilized, the polymer(s) are typically high molecular weight and viscosity-enhancing anionic polymers. In addition to increasing viscosity, the added polymer(s) may also improve a sweep efficiency of the injected fluid and increase oil production. The use of one or more polymer additives to a reservoir injection fluid in this way may be referred to as “polymer flooding” or “polymer waterflooding.”

One main problem that has arisen with many CEOR processes is that when added the polymers utilized may also render the recovery of oil from produced water more difficult. For example, anionic polymers in particular provide charge effects which stabilize the oil droplets, and thus render the oil droplets more difficult to separate from the fluid. A few solutions have been offered to reduce the negative effects of polymer addition on oil recovery. For example, chemical agents, such as cationic coagulants, have been introduced into the polymer-laden produced water in order to neutralize anionic polymers, thereby improving oil separation. Such techniques, however, require further additives and reduce or eliminate the ability of the polymer-laden fluid to be reused in a subsequent well injection. Other techniques utilize a high shear pump to break up the added polymer(s) and reduce the fluid's viscosity to allow for subsequent oil recovery steps; however, the high shear pump often results in the production of smaller droplet-sized emulsified oil, which further increases the difficulty of oil removal. Accordingly, there is a need in the art for improved oil recovery techniques for polymer-loaded fluids that allow for efficient hydrocarbon removal, as well as reuse of the treated fluid.

### SUMMARY

In accordance with an aspect, aspects of the present invention provide solutions for hydrocarbon (e.g., oil) removal from an aqueous fluid comprising an amount of hydrocarbons and one or more viscosity-enhancing polymers therein. In an embodiment, the aqueous fluid comprises polymer flood produced water derived from a CEOR process. The present inventors have surprisingly found that such fluids may be contacted with a composite media (comprising a mixture of a cellulose-based material and a polymer) for high and efficiency recovery of the hydrocarbons from the fluid while also allowing the viscosity-enhancing polymers to pass through the media and exit with the treated stream. In this way, the treated stream can advantageously be recycled or reused as an injectable fluid in a subsequent CEOR process without the requirement for significant make up polymer.

In accordance with an aspect, there is also provided a method for treating a feed stream from a chemical enhanced oil recovery (CEOR) process comprising: (i) contacting a feed stream with a plurality of media composite particles to remove hydrocarbons from the feed stream, the feed stream comprising the hydrocarbons, a concentration of a viscosity-enhancing polymer of at least about 10 mg/L, and an aqueous fluid, the media composite particles each comprising a mixture of a cellulose-based material and a polymer; and generating a treated stream comprising a reduced amount of the hydrocarbons and at least a majority of a concentration of the viscosity-enhancing polymer remaining therein relative to the feed stream.

In accordance with another aspect, there is a system for treating a feed stream from a chemical enhanced oil recovery (CEOR) process comprising: (i) a source of a feed stream comprising hydrocarbons, a concentration of a viscosity-enhancing polymer of at least about 10 mg/L, and an aqueous fluid; and (ii) a first vessel comprising a plurality of media composite particles therein effective to remove a quantity of the hydrocarbons from the feed stream and generate a treated stream comprising a reduced amount of the hydrocarbons and at least a majority of the viscosity-enhancing polymer remaining therein relative to the feed stream. The media composite particles each comprise a mixture of a cellulose-based material and a polymer.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of a system in accordance with one or more aspects of the disclosure;

FIG. 2 is a schematic drawing illustrating the generation of produced water from a CEOR process in accordance with an aspect of the disclosure;

FIG. 3 is a schematic drawing showing a plurality of vessels comprising composite media therein in series in accordance with an aspect of the disclosure.

FIG. 4 is a schematic drawing showing vessels in series along with a backwash system in accordance with an aspect of the disclosure;

FIG. 5 is a schematic drawing showing vessels in parallel along with a backwash system in accordance with an aspect of the disclosure;

FIG. 6 illustrates a vessel having a draft tube therein in accordance with an aspect of the disclosure; and

FIG. 7 is a graph illustrating the efficient removal of oil from a polymer-containing stream even at a high concentration of the polymer.

### DETAILED DESCRIPTION

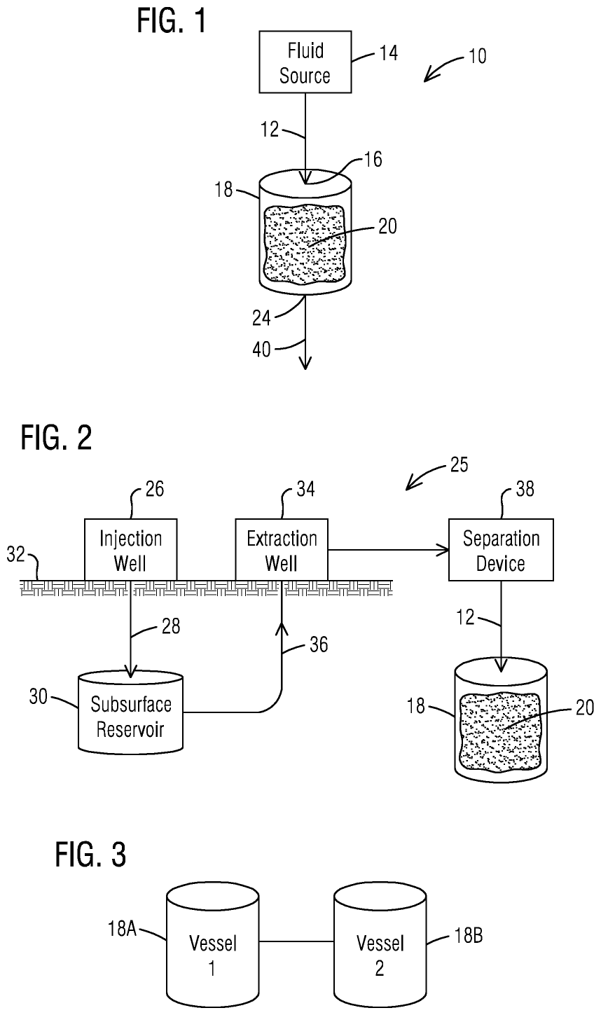

Now referring to the Figures, FIG. 1 illustrates a first embodiment of a system 10 for treating a fluid stream 12 comprising an aqueous portion, an amount of hydrocarbons, and a concentration of one or more viscosity-enhancing polymers therein. The fluid stream is provided from a suitable fluid source 14. The fluid stream 12 is delivered from the fluid source 14 to at least one inlet 16 of at least one vessel, e.g., vessel 18, which includes a plurality of media composite particles 20, which are effective to remove an amount of hydrocarbons (oil) from the fluid stream 12. In an aspect, the composite media particles 20 selectively remove hydrocarbons from the fluid stream 12 without substantially removing the viscosity-enhancing polymers therefrom, thereby allowing a treated stream 40 exiting from at least one outlet 24 of the vessel 18 to be reused, for example, as an injection fluid in a subsequent CEOR process step.

It was not obvious that the composite media particles 20 described herein would be effective to remove hydrocarbons without also removing the viscosity-enhancing polymer(s) from the fluid. To explain, subsurface oil is typically present in a formation of sand and rock. As described above, the use of viscosity-enhancing polymers in an injection fluid renders the injection fluid more effective for pushing oil out of that formation. Conventional wisdom would lead the skilled artisan to believe that the viscosity of the resulting produced water (still loaded with the viscosity-enhancing polymers) would also push the oil through a bed of media rather than adequately collect the oil. However, the present inventors have surprisingly found that the composite media particles provided excellent hydrocarbon removal from such polymer-laden streams with the added benefit of minimal retention of the polymers as well.

The fluid stream 12 comprises an aqueous-based liquid which comprises at least an amount of hydrocarbons therein and an amount of one or more viscosity-enhancing polymers therein. In an embodiment, the concentration of viscosity-enhancing polymer is at least about 10 mg/L, which is an amount that typically tends to increase the difficulty of oil recovery from the fluid stream 12. In certain embodiments, there may be further additives to the fluid stream 12. For example, there may be further additives in the fluid stream 12 for use in a CEOR process, such as alcohols, hydrophilic additives, stabilizers, salts, surfactants, and the like.

The hydrocarbon (oil) concentration in the stream 12 may be any suitable amount which may be handled by the system 10. In an embodiment, the stream 12 comprises a hydrocarbon concentration of at least about 10 mg/L, and in a particular embodiment, from about 100-1500 mg/L, and in a further embodiment from about 250 to about 1000 mg/L. As used herein, the term “about” refers to a value that is ±5% of the stated value. As used herein, the term “hydrocarbon” refers to organic material with molecular structures containing carbon bonded to hydrogen. Hydrocarbons may also include other elements, such as, but not limited to, at least one of halogens, metallic elements, nitrogen, oxygen, and sulfur. Typically, the hydrocarbons are in the form of a hydrocarbon liquid, such as crude oil, shale oil, pyrolysis oil, and any combination thereof dispersed within the aqueous portion of the stream 12. As used herein also, the term “aqueous based” means that the fluid stream 12 comprises a liquid portion that at least comprises water, although the fluid stream 12 may further comprise additional substances, such as solids, including suspended solids, other liquids, gases, or any combination thereof.

Referring to FIG. 2, it is shown the fluid stream may be derived from a CEOR process. FIG. 2 illustrates a simplified chemical enhanced oil recovery (CEOR) system 25 comprising an injection well 26 which injects a polymer flood 28 as is known in the art into a subsurface oil reservoir 30. The polymer flood 28 comprises an aqueous fluid including an amount of a viscosity-enhancing polymer as described herein, and optionally one or more further additives. Following injection, the polymer flood 28 returns to the surface 32 via an extraction well 34 along with recovered oil from the oil reservoir 30 (collectively “extraction fluid 36”). The extraction fluid 36 can be directed to one or more separation devices 38 for bulk removal of hydrocarbons (oil) and in some instances suspended solids therefrom and to generate the fluid stream 12 for treatment in vessel 18 as described herein. Thus, in an embodiment, the extraction fluid 36 is delivered indirectly or directly to the one or more separation devices 38 to generate the fluid stream 12 as shown in FIG. 2. In other embodiments, the extraction fluid 36 comprises the fluid stream 12 for treatment in vessel 18 without any pretreatment by the one or more separation devices 38 or the like. Thus, in an embodiment, the extraction fluid 36 is delivered indirectly or directly to vessel 18 for treatment with composite media particles 20 without being directed to the one or more separation devices 38.

Without limitation, the one or more separation devices 38 may include an API separator, a gravity clarifier, a floatation device (e.g., an API flotation device, a dissolved air flotation (DAF) device, a dissolved gas flotation (DGF) device, a compact flotation device, combinations thereof, and the like) to separate bulk amounts of oil and suspended solids from the extraction fluid 36. In an embodiment, the fluid stream 12 that is directed to the vessel 18 comprising media composite particles 20 comprises an effluent from the one or more separation devices 38. In this way, the fluid stream 12 may thus be referred to as “produced water” from a CEOR process based upon the fact at least some of the components therein in the stream 12 from the polymer flood 28 as set forth above. In certain embodiments, this fluid stream 12 from the one or more separation devices 38 comprises a hydrocarbon concentration of at least about 10 mg/L, and in certain embodiments from 100 to 1500 mg/L; however, it is understood that the present invention is not so limited.

Polymer

In the stream 12, the viscosity-enhancing polymer may be any polymer which provides the fluid stream 12 with a greater degree of viscosity than the fluid stream without the viscosity-enhancing polymer and/or increases the mobility of hydrocarbons (oil) in the subsurface oil reservoir into which the stream 12 is injected. The polymer may be any suitable material which brings about one or both of these properties/effects. Further, as used herein, the term “polymer” denotes a covalently bonded chain of monomer units, and is intended to include both homopolymers and copolymers. In certain embodiments, the polymer further comprises water soluble chemical groups which render the polymer chains water soluble.

In an embodiment, the polymer comprises an anionic polymer, which is believed to stabilize oil droplets due to steric and repulsion effects and thus make oil recovery more difficult. The anionic polymer may comprise anionic functional groups within the polymer chain itself or added to the chain as pendent functional groups. In specific embodiments, the anionic polymer may comprise a hydrolyzed polyacrylamide (HPAM). In HPAM, at least portion of its amide groups are hydrolyzed to carboxyl groups. The carboxyl groups may, in turn, dissociate to form anionic carboxylate groups associated with the polymer chain in an aqueous solution. In certain embodiments, HPAM is typically considered hydrolyzed when the carboxylate content is greater than 2 mole percent. However, the mole percent may be substantially greater, such as at least about 30 mole percent, and in certain embodiment from about 30-35 mole percent. In addition, in certain embodiments, the HPAM may be in an acid or salt form, and in some embodiments may be in a salt form. The amount of polymer in the fluid stream 12 may vary. In practice, it has been seen that as viscosity-enhancing polymer concentrations increase from 10 mg/L and above, hydrocarbon removal from such hydrocarbon and polymer-containing streams (e.g., stream 12) becomes increasingly difficult. Aspects of the present invention allow for hydrocarbon removal even in the presence of a polymer as described herein. Specifically, the viscosity-enhancing polymer concentration in the stream 12 is about 10 mg/L or more. In certain embodiments, the viscosity-enhancing polymer concentration may be about 50 mg/L or more. In particular embodiments, the viscosity-enhancing polymer concentration may be from about 50 mg/L to about 1500 mg/L.

As mentioned, the feed stream 12 is typically introduced into one or more inlets 16 of a vessel 18. As used herein, the term “vessel” broadly refers to any structure suitable for confining one or more process materials as described herein, including gas, liquid and solid components and mixtures thereof. The vessel 18 may be open to the environment or may be closed to operate under pressure. In addition, the vessel 18 may be sized and shaped according to a desired application and volume of feed to be treated to provide at least one of a desired throughput and a desired period of operation before a backwash is initiated. Further, the vessel 18 may have a bed to accommodate the composite media particles 20 at a desired depth based upon the desired volume of feed to be treated. The vessel 18 may be constructed of any material suitable for the purposes of the methods and systems described herein. Non-limiting examples of suitable materials include steel, stainless steel, fiberglass reinforced plastic, and polyvinyl chloride (PVC).

In certain embodiments, the composite media particles 20 may be contained within the vessel 18 by one or more dividers, such as screens or perforated plates, which may retain the media in a desired location within the vessel 18 while allowing one or more liquids to flow throughout the composite media in the vessel 18. The vessel 18 further comprises one or more outlets 24 for exit of the treated stream 40 therefrom. In certain embodiments, a concentration of hydrocarbons in the effluent is an amount that complies with regulatory requirements on wastewater discharge.

Composite Media

Each vessel 18 described herein may include a bed (media bed) of the media composite particles. The media composite particles 20 as described herein each comprise a mixture of a cellulose-based material and a polymer. In certain embodiments, the media composite particles 20 may each comprise a heterogeneous mixture of the cellulose-based material and the polymer. The heterogeneous mixture may comprise the ingredients or constituents such that the cellulose-based material and polymer are not distributed uniformly throughout the mixture. As used herein, the term “heterogeneous mixture” refers to a composite of two or more dissimilar ingredients or constituents. In other embodiments, the media composite particles 20 may each comprise a homogeneous mixture of the cellulose-based material and the polymer. In one embodiment, the media composite particles 20 may comprise the cellulose-based material and polymer such that the two materials are secured to one another, but are not mixed with one another. Further, as used herein, the term “homogeneous mixture” refers to a composite that is a single-phase composite of two or more components (e.g., cellulose-based material and polymer) that are distributed in a uniform ratio or in a substantially uniform ratio throughout the mixture so that any portion of the composite media particles 20 exhibit the same ratio of the two or more components.

As used herein, the term “cellulose-based material” refers to any material, product, or composition which contains cellulose. Non-limiting examples may include wood from deciduous and evergreen trees, including wood powder, wood pulp, wood particles, wood fibers, sawdust, wood flakes, wood chips, and any other wood product or cellulose-based product suitable for the methods and systems disclosed herein, such as, coconut, bagasse, peat, pulp-mill waste, corn stalks, and any combination thereof. The media composite particles 20 may comprise any wood suitable for the purposes of the methods and systems described herein. In certain embodiments, the cellulose-based material may be pine wood. In certain embodiments, the cellulose-based material may be maple wood.

Non-limiting examples of polymers suitable for use in the particles 20 may include polyolefins, including high density polyethylene (HDPE), polyethylene (PE), polypropylene (PP), PVC, ethylene propylene copolymers, fluoropolymers, including Teflon®, and any combination thereof. In at least one embodiment, the polymer may be HDPE. In another embodiment, the polymer may comprise polypropylene.

The concentration of cellulose-based material in the particles 20, individually or as a whole, may be any percentage between about 10% and about 99%, or any range of percentages in between these percentages. In certain embodiments, the media composite particles 20 may collectively comprise a concentration of cellulose-based material of at least about 50%. In other embodiments, the media composite particles 20 may collectively comprise a concentration of cellulose-based material of at least about 60%. In certain embodiments, the media composite particles 20 may collectively comprise a concentration of cellulose-based material of at least about 70%. In at least one embodiment, the media composite particles 20 may collectively comprise a concentration of maple wood of about 50% by weight. In another embodiment, the media composite particles 20 may collectively comprise a concentration of pine wood of about 70% by weight.

In at least one aspect, the media composite particles 20 comprise a plurality of uniformly shaped particles. As used herein, the term “uniformly shaped particles” refers to exactly the same shaped and size particles and substantially the same shaped and sized particles, while tolerating some degree of difference in shape attributable to, for example, manufacturing error. Suitable shapes for the media composite particles 20 may include spheres and cylinders. For example, the media composite particles 20 may comprise a plurality of uniformly shaped cylinder or cylinder-like shapes. The media composite particles 20 may be of any shape that may allow for gaps in the interstitial area between the particles. The presence of such interstitial gaps is critical as during filtration, hydrocarbons may be adsorbed to a surface of the particles 20 and maintained within the bed of media composite particles 20 in the vessel 18. In other embodiments, the media composite particles 20 may comprise a plurality of irregularly shaped particles. In still further embodiments, the media composite particles 20 may comprise additional components. Non-limiting examples of components that may be suitable to include in the media composite include coagulants and flocculants.

Two or More Vessels

Although FIG. 1 illustrates a single vessel 18 comprising a plurality of the media composite particles 20, it is understood that the present invention is not so limited. In certain embodiments, two or more vessels 18 (18A, 18B each comprising particles 20) may be provided in parallel (not shown) or in series as shown in FIG. 3. In one aspect, the present inventors have found that providing two or more vessels 18A, 18B (e.g., two) in series increased a degree of hydrocarbon removal relative to one vessel 18. In certain embodiments, two vessels 18A, 18B were effective to remove 70% or move by volume of the hydrocarbon content from the feed stream 12. In still other embodiments, more than two vessels 18 may be provided such that one or more vessels 18A may be in use to treat an incoming feed stream 12 while at least one other 18B is taken out of service to be backwashed with a suitable backwash fluid in order to carry retained hydrocarbons (oil) from the bed of media composite particles 20, namely in the interstitial gaps between the particles 20, and allow the media composite particles 20 to be reused in a subsequent treatment step. In other embodiments, a plurality of vessels 18A, 18B may be provided in series to facilitate efficient hydrocarbon removal. In an aspect, by placing two vessels 18A, 18B in series, the amount of backwash water required and produced is able to be reduced. The first vessel 18A removes the majority of oil out from the fluid stream 12 while the second vessel 18B polishes the stream 12. Accordingly, the second vessel 18B may be backwashed less often, e.g., half as much, as the first vessel 18A, thereby reducing the amount of backwash water 44 produced. In certain embodiments, as shown in FIG. 5, a plurality of vessels 18 may be provided in parallel such that when one set of vessels 18A, 18B are taken out of service, the system 10 still includes multiple vessels 18C, 18D ready to treat the stream 12.

Backwash

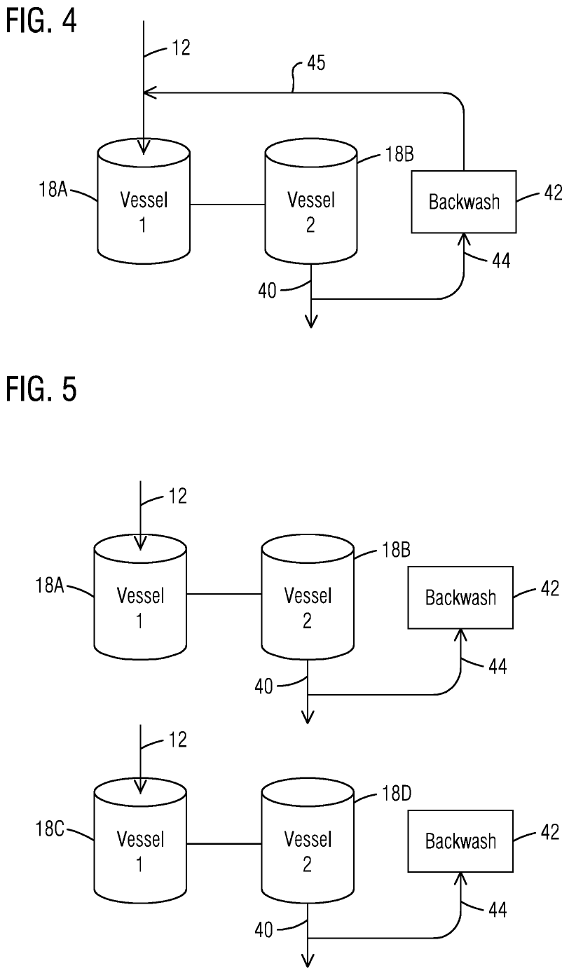

To accomplish the backwashing, as is best shown in FIG. 4, the systems and processes described herein may be provided with a source 42 of a backwash fluid 44. The source 42 is in fluid communication with the vessel(s) 18 of the system 10 in order to deliver an effective amount of the backwash fluid 44 at a suitable flow to the media composite particles 20 in order to restore the particles 20 for reuse. Typically, this is accomplished within a selected vessel by ceasing any inflow of the stream 12 to the vessel 18 and allowing flow of the backwash fluid 44 to the vessel. Typically also, the backwash fluid 44 is delivered to and through the particles 20 in a direction opposite to which the feed stream 20 is introduced, although the present invention is not so limited. The backwashing of the media composite particles 20 with the backwash fluid 44 produces a hydrocarbon liquid effluent 45 comprising removed hydrocarbons from the particles 20. In certain embodiments, to reduce the need for waste disposal, the effluent 45 comprising removed hydrocarbons may be combined with the feed stream (12) and thereafter again contacted with the plurality of media composite particles (20) as is also shown in FIG. 4.

In certain embodiments, backwashing is initiated upon the determining that a hydrocarbon content of the treated stream 40 has exceeded a predetermined concentration. Backwashing the media composite may be based on additional performance characteristics of the treatment system. For example, in certain aspects, backwashing the media composite particles 20 may be based on a pressure drop across the media bed of the particles 20. For example, a sensor may generate a signal indicating that the pressure drop over the media bed has reached a predetermined value. This may trigger a controller to interrupt or otherwise intercept one or more flows in the treatment system to initiate a backwash procedure. The backwash fluid 44 may comprise any suitable aqueous-based fluid, such as a fresh water fluid. In some embodiments, if desired, a portion of the treated effluent 40 may be utilized as the backwash fluid 44 in order to reduce material costs for the system by reducing or eliminating the requirement for additional or make up backwash fluid 44. In still further embodiments, at least a portion of the fluid stream 12 may be utilized as the backwash fluid.

Draft Tube

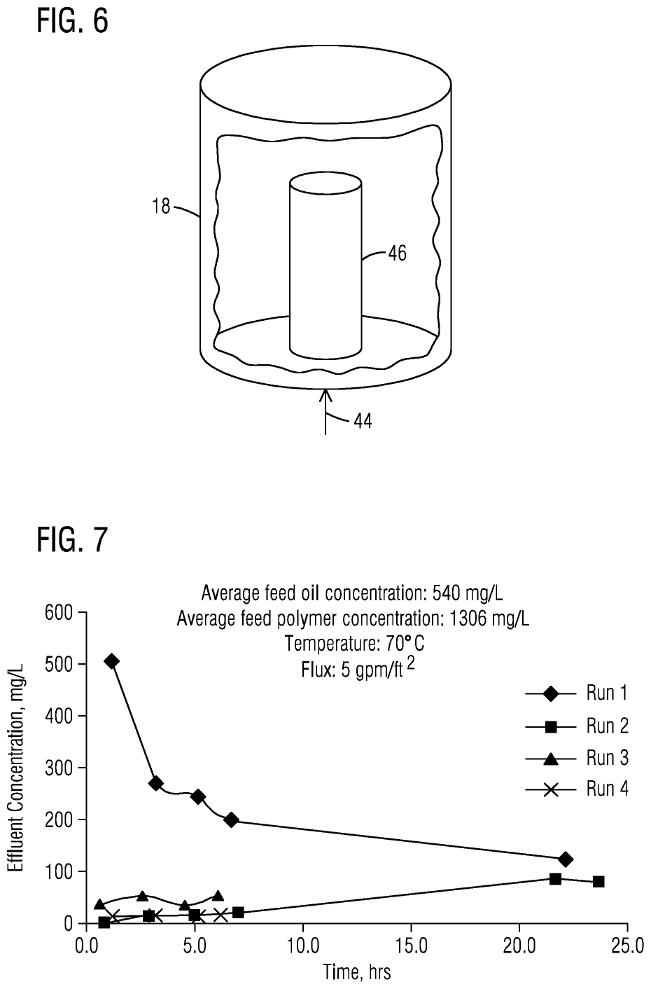

In certain aspects, the vessel 18 may be also be fitted with a draft tube system. The draft tube system may comprise one or more draft tubes 46 as shown in FIG. 6, and may be constructed and arranged to intermittently backwash the composite media particles 20 by providing a desired volume and/or velocity of the backwash fluid 44 to roll the bed. In certain embodiments, the backwash fluid 44 is introduced into the vessel 14 such that the backwash fluid travels through the draft tube(s) with the media particles 20. As used herein, “rolling the bed” is defined as the movement of the media particles 20 during backwash in which the media particles 20 at or near one wall of the vessel 18 may be partially or completely moved through the draft tube system toward another wall of the vessel and back toward the first wall. Backwashing may be performed with a draft tube system in place, or may be performed without a draft tube system. The draft tube(s) 46 may be sized and shaped to provide for at least one of a desired volume of media particles 20 to be backwashed and to operate within a preselected time period for backwash operation. Exemplary draft tube systems for use in the present invention are described and shown in US Published Patent Application No. 2011/0174746, the entirety of which is incorporated by reference herein.

In one aspect, the “draft tube” is a structure having one or more sidewalls open at both ends which, when positioned in the media bed, provides a passageway for flow of the media particles 20 during backwash. In certain embodiments, the vessel 18 may have a volume of media that is about 4 to about 6 times the volume of a draft tube or the summation of the volumes of the draft tubes 46 in the draft tube system. The draft tube(s) 46 may be constructed of any material suitable for the particular purposes of the methods and systems described herein. For example, the draft tube(s) 46 may be formed of the same material as the vessel, or may be formed of a different material. In certain embodiments, the draft tube(s) 46 may be supported on a wall of the vessel 18. Alternatively, the draft tube(s) 46 may be supported on a divider or media retention plate, such as a screen or perforated plate, designed to retain the composite media particles 20 within a region of the vessel 18 while allowing the flow of liquid and contaminants into and out of the media particles 20.

The draft tube(s) 46 may be positioned at any suitable location within the media. In one embodiment, a vessel 18 may have a first draft tube centrally positioned having a first cross sectional area and a plurality of second draft tubes positioned adjacent the side wall of the vessel in which each of the second draft tubes has a second cross sectional area smaller than the first cross sectional area. In another embodiment, the vessel 18 has a plurality of identically-sized draft tubes.

Process

In accordance with another aspect, there is provided a method for treating a feed stream, e.g., produced water, from a chemical enhanced oil recovery (CEOR) process. The method comprises contacting a feed stream 12 with a plurality of media composite particles 20 to remove hydrocarbons from the feed stream 12. The feed stream 12 comprises an amount of hydrocarbons, a concentration of a viscosity-enhancing polymer of at least about 10 mg/L, and an aqueous fluid. The media composite particles 20 each comprise a mixture of a cellulose-based material and a polymer. From the contacting, the method comprises generating a treated stream (40) comprising a reduced amount of the hydrocarbons relative to the feed stream 12 and at least a majority of the viscosity-enhancing polymer remaining therein. In certain embodiments, the viscosity-enhancing polymer comprises hydrolyzed polyacrylamide (HPAM).

In accordance with an aspect, the feed stream 12 may be introduced to an upstream (relative to the vessel 18) separation device 38 for the separation of bulk solids and hydrocarbons from the feed stream. In an embodiment, the separation device 38 may include one or more of an API separator, a gravity clarifier, or a floatation device (e.g., an API flotation device, a dissolved air flotation (DAF) device, a dissolved gas flotation (DGF) device, a compact flotation device, and the like).

In an embodiment, the hydrocarbon concentration may be reduced by at least about 80% of its concentration in the feed stream 12 by the plurality of media composite particles 20. In addition, the treated stream 40 comprises of a concentration of the polymer in the feed stream 12 such that the media particles 20 remove a minimal amount of polymer from the feed stream 12. More specifically, the treated stream 40 comprises at least a majority (>50%) of a concentration of the polymer from the feed stream 12. In a particular embodiment, the treated stream 40 comprises at least about 80% of a concentration of the polymer from the feed stream 12. In this way, the processes may further comprise reusing the treated stream as a completion fluid in an oil production process, e.g., a CEOR process. In certain embodiments, the treated stream 40 comprises a hydrocarbon concentration of about 30 ppm or less, and in certain embodiments from 10 ppm or less.

In another aspect, multiple vessels 18 comprising a plurality of composite media particles 20 may be provided such that the fluid stream 12 flows through at least two vessels 18A, 18B to improve hydrocarbon recovery therefrom. Accordingly, the method may further comprise introducing the feed stream into a first vessel 18A comprising a plurality of the media composite particles 20 and then introducing the feed stream into a second vessel 18B comprising a plurality of the media composite particles 20 in flow series with the first vessel 18A (FIG. 4). When the media composite particles 20 have become saturated with hydrocarbons, the particles 20 may be backwashed with a suitable backwash fluid (e.g., freshwater or the effluent from an associated vessel 18) to ready the particles 20 for further use in treating fluid stream 12. In certain embodiments, backwashing the media composite particles 20 may be triggered, commenced, or based on a measurement of the concentration of hydrocarbon liquid in the treated stream, which may trigger or commence a backwashing step. Further, in another aspect, the method may further comprise recycling the hydrocarbon liquid effluent from backwashing to the feed stream 12.

In summary, unlike conventional produced water treatment technologies, the described systems and processes can be highly efficient at treating produced water from polymer flood applications. By way of example, the systems and processes described herein may operate in the presence of viscous polymer at industry accepted flux rates while:
a) removing a significant amount of oil in the feed steam to 30 ppm or less in the effluent, for example;
b) not consuming any chemicals;
c) allowing the polymer to be unchanged during treatment;
d) allowing reinjection of the final effluent;
e) requiring low amounts, if any, of make up polymer for reinjection; and
f) providing low concentrations of oil/total suspended solids in the effluent.

### EXAMPLES

The systems and methods described herein will be further illustrated through the following examples, which are illustrative in nature and are not intended to limit the scope of the disclosure.

### Example 1

Three test conditions were tested with the composite media with polymer (e.g., anionic hydrolyzed polyacrylamide) in the fluid. A summary of the test conditions are set forth in Table 1 below. During this round of testing, the flux was 5 gallons per minute per square foot (gpm/ft²) and the water temperature was 70° C. The polymer concentration was calculated off the tank level change and the oil concentration was calculated by the change in weight of the oil bucket on the scale.

TABLE 1
Test condition feed characteristics:

| | Polymer | Oil | | |
|---|---|---|---|---|
| Test | Concentration | Concentration | Flux | Temperature |
| Condition | (mg/L) | (mg/L) | (gpm/ft²) | (° C.) |
| 1 | 809 | 275 | 5 | 70 |
| 2 | 546 | 385 | 5 | 70 |
| 3 | 1306 | 540 | 5 | 70 |

At 1306 mg/L polymer, the effectiveness of the disclosed processes and systems is illustrated in FIG. 7. During Condition 3, the feed oil concentration was 540 mg/L and the polymer concentration was 1306 mg/L. As shown by the results in FIG. 6, the composite media was able to remove at least about 80% of the total oil in the feed—even with a very high concentration of polymer present.

### Example 2

Under the following parameters, two vessels (V1, V2) comprising the composite media were placed in series and a feed stream comprising the below oil and polymer concentrations were introduced through the vessels at the below fluxes. As can be seen, the introduction of the second vessel (V2) further improved total oil removal for the system.

TABLE 2

| | | | | | | V2 | | System |
|---|---|---|---|---|---|---|---|---|
| | | | | V1 | | Effluent | V2 | Total |
| | | Feed | Polymer | Effluent Oil | V1 Oil | Oil | Oil | Oil |
| Test | Flux | Oil | Concentration | Concentration | Removal | Concentration | Removal | Removal |
| # | (mg/L) | (mg/L) | (mg/L) | (mg/L) | (%) | (mg/L) | (%) | (%) |
| 1 | 5 | 292 | 593 | 35.2 | 87.9 | 8.0 | 77.3 | 97.3 |
| 2 | 5 | 438 | 458 | 61.6 | 85.9 | 18.8 | 69.5 | 95.7 |
| 3 | 5 | 459 | 443 | 107.7 | 76.5 | 19.7 | 81.7 | 95.7 |
| 4 | 5 | 409 | 449 | 104.8 | 74.4 | 16.5 | 84.3 | 96.0 |
| 5 | 7.5 | 252 | 486 | 170.6 | 32.3 | 10.2 | 94.0 | 96.0 |
| 6 | 10 | 241 | 493 | 46.1 | 80.9 | 6.2 | 86.6 | 97.4 |
| 7 | 12.5 | 244 | 484 | 98.7 | 59.5 | 9.5 | 90.4 | 96.1 |
| 8 | 15 | 238 | 141 | 138.6 | 41.8 | 16.5 | 88.1 | 93.1 |
| 9 | 10 | 232 | 535 | 80.2 | 65.4 | 7.0 | 91.3 | 97.0 |

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “involving,” “having,” “containing,” “characterized by,” “characterized in that,” and variations thereof herein is meant to encompass the items listed thereafter, equivalents thereof, as well as alternate embodiments consisting of the items listed thereafter exclusively. Use of ordinal terms such as “first,” “second,” “third,” and the like in the claims to modify a claim element does not by itself connote any priority. The use of singular and plural terms is not intended to be limiting. When an article or material is described in the singular, for example, it shall be understood that by “a” or “an,” it is meant “one or more” of such articles or materials. Similarly, when an article or material is described in the plural, it shall be understood that such description includes a single one of the same article or material.

While exemplary embodiments of the disclosure have been disclosed many modifications, additions, and deletions may be made therein without departing from the spirit and scope of the disclosure and its equivalents, as set forth in the following claims. Those skilled in the art would readily appreciate that the various parameters and configurations described herein are meant to be exemplary and that actual parameters and configurations will depend upon the specific application for which the systems and methods directed toward separation treatment processes using composite media of the present disclosure are used. Those skilled in the art will recognize, or be able to ascertain using no more than routine experimentation, many equivalents to the specific embodiments described herein.

For example, those skilled in the art may recognize that the apparatus, and components thereof, according to the present disclosure may further comprise a network of systems or be a component of a separation treatment process using a composite media system. It is, therefore, to be understood that the foregoing embodiments are presented by way of example only and that, within the scope of the appended claims and equivalents thereto, the disclosed separation treatment processes using composite media systems and methods may be practiced otherwise than as specifically described. The present apparatus and methods are directed to each individual feature or method described herein. In addition, any combination of two or more such features, apparatus or methods, if such features, apparatus or methods are not mutually inconsistent, is included within the scope of the present disclosure.

In some cases, the apparatus and methods may involve connecting or configuring an existing facility to comprise a separation treatment processes using composite media. Accordingly, the foregoing description and drawings are by way of example only. Further, the depictions in the drawings do not limit the disclosures to the particularly illustrated representations.

1. A method for treating a feed stream (12) from a chemical enhanced oil recovery (CEOR) process comprising:
contacting a feed stream (12) with a plurality of media composite particles (20) to remove hydrocarbons from the feed stream (12), the feed stream (12) comprising the hydrocarbons, a concentration of a viscosity-enhancing polymer of at least 10 mg/L, and an aqueous fluid, the media composite particles (20) each comprising a mixture of a cellulose-based material and a polymer; and
generating a treated stream (40) comprising a reduced amount of the hydrocarbons and at least a majority of a concentration of the viscosity-enhancing polymer remaining therein relative to the feed stream (12).

2. The method of claim 1, wherein the polymer comprises hydrolyzed polyacrylamide (HPAM).

3. The method of claim 1, wherein the concentration of a viscosity-enhancing polymer in the feed stream is 50 mg/L or more.

4. The method of claim 1, wherein the treated stream comprises a hydrocarbon concentration of 30 ppm or less.

5. The method of claim 1, wherein the contacting reduces an amount of hydrocarbons in the feed stream (12) by at least 80% relative to a concentration of hydrocarbons in the treated stream (40).

6. The method of claim 1, wherein the treated stream (40) comprises at least 80% of a concentration of the polymer from the feed stream (12).

7. The method of claim 1, wherein the feed stream (12) further comprises an additive selected from the group consisting of an alcohol, a hydrophilic additive, a stabilizer, a salt, a surfactant, and combinations thereof.

8. (canceled)

9. The method of claim 1, further comprising reusing the treated stream (40) as a completion fluid in an oil production process.

10. The method of claim 1, wherein a concentration of the hydrocarbons in the feed stream (12) is from 100 to 1500 mg/L.

11. The method of claim 1, wherein the contacting comprises introducing the feed stream (12) into a first vessel (18A) comprising the media composite particles (20), and introducing the feed stream into a second vessel (18B) comprising the media composite particles (20) in flow series with the first vessel (18A).

12. (canceled)

13. The method of claim 1, further comprising backwashing the media composite particles (20) to produce a hydrocarbon liquid effluent (45); combining the hydrocarbon liquid effluent (45) with the feed stream (12), and contacting the feed stream (12) and hydrocarbon liquid effluent (45) with the plurality of media composite particles (20).

14. A system (10) for treating a feed stream from a chemical enhanced oil recovery (CEOR) process comprising:
a source of a feed stream (12) comprising hydrocarbons, a concentration of a viscosity-enhancing polymer of at least 10 mg/L, and an aqueous fluid; and
a first vessel (18A) comprising a plurality of media composite particles (20) therein effective to remove a quantity of the hydrocarbons from the feed stream (12) and generate a treated stream (40) comprising a reduced amount of the hydrocarbons and at least a majority of the viscosity-enhancing polymer remaining therein relative to the feed stream (12);
wherein the media composite particles (20) each comprise a mixture of a cellulose-based material and a polymer.

15. The system (10) of claim 14, wherein the polymer comprises hydrolyzed polyacrylamide (HPAM).

16. The system (10) of claim 14, wherein the concentration of a viscosity-enhancing polymer in the feed stream is 50 mg/L or more.

17. The system (10) of claim 14, wherein the feed stream (12) further comprises an additive selected from the group consisting of an alcohol, a hydrophilic additive, a stabilizer, a salt, a surfactant, and combinations thereof.

18. The system (10) of claim 14, wherein the feed stream (12) comprises produced water from a CEOR process.

19. The system (10) of claim 14, wherein a hydrocarbon concentration in the feed stream (12) is from 100 to 1500 mg/L.

20. The system (10) of claim 14, further comprising a second vessel (18B) comprising a plurality of the media composite particles (20) in flow series with the first vessel (18A), and a source (42) of a backwash fluid (44) in fluid communication with an inlet of the first vessel (18A) to deliver an amount of the backwash fluid to the first vessel (18A) or the second vessel (18B).

21. (canceled)

22. The system (10) of claim 14, further comprising a separator device (38) upstream from the first vessel (18A), the separator device (38) comprising at least one of a hydrocyclone, a filter device, a gravity settling device, and a flotation device.

23. The system (10) of claim 14, wherein the cellulose-based material comprises maple wood, and wherein the polymer comprises high density polyethylene.
